(19) United States
(12) Patent Application Publication
(10) Pub. No.: US 2013/0071684 A1
(43) Pub. Date: Mar. 21, 2013

(54) HOUSEHOLD APPLIANCE INCLUDING A FASCIA PANEL HAVING A METALLIC FILM

(71) Applicants: Casey Carr, New Bern, NC (US); Michael Justis, New Bern, NC (US)

(72) Inventors: Casey Carr, New Bern, NC (US); Michael Justis, New Bern, NC (US)

(73) Assignee: BSH HOME APPLIANCES CORPORATION, Huntington Beach, CA (US)

(21) Appl. No.: 13/233,054

(22) Filed: Sep. 15, 2011

(51) Int. Cl. B32B 15/04; B32B 37/14; B32B 37/12; B32B 15/10; B32B 7/12

(52) U.S. Cl. 428/615; 428/457; 428/464; 156/60

(57) ABSTRACT

A household appliance including at least one fascia panel, wherein the at least one fascia panel includes a film having a metallic material that provides a metallic appearance to the at least one fascia panel. In an exemplary embodiment of the invention, the metallic material may include one of a stainless steel material and a brushed nickel material. Further, the fascia panel may be formed from at least one of plastic, wood, and metal.

### BACKGROUND OF THE INVENTION

1. Field of the Invention

The present invention relates to a household appliance and more particularly, to a household appliance including a fascia panel having a metallic film and method for manufacturing thereof that allows for the panel to have the appearance of a metallic panel.

2. Related Art

In the related art, the cabinet of a household appliance, such as a dishwasher or refrigerator may be formed from panels made from, for example, a stainless steel or brushed nickel material. While these materials are durable and provide a certain modern aesthetic to the household appliance, they are relatively expensive to manufacture in comparison to other materials such as plastic or rolled steel.

Another way to create a metallic look during manufacturing is by treating the surface of ordinary steel in order to achieve the desired look. For example, as disclosed in commonly owned DE102005050181, a surface of a panel is first treated against corrosion with a layer of transparent varnish that serves as a barrier and is made of an inorganic chemical. The layer is then polished or brushed. The coarse surface is then sealed with an acrylic lacquer, an epoxy layer, or a layer of nano-material providing a stainless steel look.

However, the material costs for manufacturing the panels from a metal are more expensive than if the panels were made from a material such as plastic. Yet, a plastic panel does not provide the modern aesthetic desired by today's consumers. The present invention introduces a household appliance and a method of manufacturing the household appliance where the metallic aesthetic can be replicated in a cost-efficient manner.

### SUMMARY OF THE INVENTION

A first aspect of the present invention is directed to a household appliance. The household appliance may include at least one fascia panel, wherein the at least one fascia panel includes a film having a metallic material that provides a metallic appearance to the at least one fascia panel. The metallic material may include one of a stainless steel material and a brushed nickel material. Also, the fascia panel may be formed from at least one of plastic, wood, and metal.

A second aspect of the present invention is directed a method of manufacturing the household appliance. In the second aspect, the method may include the steps of adhering a film comprising a metallic material on at least one fascia panel of the household appliance to provide a metallic appearance to the at least one fascia panel. The film may be adhered to a side of the at least one fascia panel using an adhesive.

The illustrative aspects of the present invention are designed to solve the problems herein described and other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various exemplary embodiments of the disclosure, in which:

FIG. 1 depicts a household appliance including a fascia panel having a metallic film; and

FIG. 2 depicts a method for manufacturing a household appliance according to an exemplary embodiment of the invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

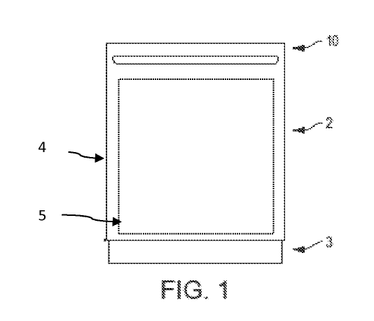

FIG. 1 shows an exemplary embodiment of a household appliance of the present invention, such as a dishwasher 10. The dishwasher 10 may comprise a door 2 which is suitable for tiltable opening. On a lower side of the door 2, the dishwasher 10 may include at least one of a base cover or toe panel 3. The base cover/toe panel 3 may protect a user of the dishwasher 10 from inadvertently accessing a space where the electronics and other functional components (not shown) of the dishwasher 10 may be located, thereby protecting both the user for safety purposes and the electronic components from damage.

One or both of the door 2 and toe panel 3 may include a fascia panel 4, wherein the fascia panel may include a film 5 comprising a metallic material that provides a metallic appearance to the fascia panel 4. Accordingly, the door 2 and/or toe panel 3 and accompanying fascia panels 4 made be made of a less expensive material such as plastic, wood, or a metal material other than stainless steel or nickel to reduce the manufacturing costs of the dishwasher 10 while still maintaining the metallic aesthetic. In one embodiment, the metallic material of the film is one of a stainless steel material and a brushed nickel material.

The film 5 may be formed to have physical properties that will maintain the metallic aesthetic during normal household use. For example, the film 5 may be scratch resistant, heat resistant, and/or water resistant. The film 5 may be formed, for example, to be heat resistant in operating conditions of the household appliance such as from about −14° F. to 122° F.

In another exemplary embodiment of the invention, the film 5 may include a magnetizable material so that a magnetic label or other magnetic insignia may be attached (not shown). This may include, for example, a film 5 that includes a rolled steel layer. In yet another exemplary embodiment, the film 5 may be coated with a tinted material to provide a color appearance to the fascia panel 4.

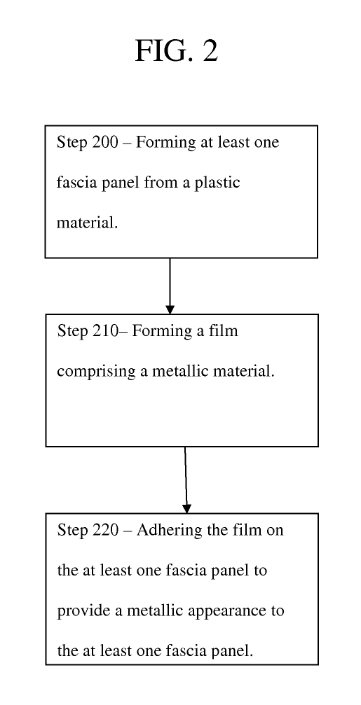

An exemplary method of the invention is depicted in FIG. 2. The method may include at step 200, forming at least one fascia panel from a material such as plastic. At step 210, a film may be formed wherein the film comprises a metallic material such as, for example, stainless steel. Finally, at step 220, the film may be adhered to the at least one fascia panel to provide a metallic appearance to the at least one fascia panel.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A household appliance, comprising:
at least one fascia panel, wherein the at least one fascia panel includes a film comprising a metallic material that provides a metallic appearance to the at least one fascia panel.

2. The household appliance according to claim 1, wherein the metallic material is one of a stainless steel material and a brushed nickel material.

3. The household appliance according to claim 1, wherein the at least one fascia panel is formed from at least one of a plastic, wood, and metal material.

4. The household appliance according to claim 1, wherein the film is scratch resistant.

5. The household appliance according to claim 1, wherein the film is heat resistant.

6. The household appliance according to claim 5, wherein the film is heat resistant from −14° F. to 122° F.

7. The household appliance according to claim 1, wherein the film is water resistant.

8. The household appliance according to claim 1, wherein the film includes a magnetizable material.

9. The household appliance according to claim 1, wherein the film includes a rolled steel layer.

10. The household appliance according to claim 1, wherein the film includes an adhesive layer on a side applied to the at least one fascia panel for adhering the film to the at least one fascia panel.

11. The household appliance according to claim 1, wherein the film is coated with a tinted material to provide a color appearance to the at least one fascia panel.

12. A method of manufacturing a household appliance comprising the steps of:
adhering a film comprising a metallic material on at least one fascia panel of the household appliance to provide a metallic appearance to the at least one fascia panel.

13. The method of claim 12, further comprising adhering the film to a side of the at least one fascia panel using an adhesive.

14. The method of claim 12, wherein the metallic material is one of a stainless steel material and a brushed nickel material.

15. The method of claim 12, further comprising forming the at least one fascia panel from at least one of a plastic, wood, and metal material.

16. The method of claim 12, wherein the film is scratch resistant.

17. The method of claim 16, wherein the film is heat resistant from −14° F. to 122° F.

18. The method of claim 12, wherein the film is water resistant.

19. The method of claim 12, wherein the film includes a magnetizable material.

20. The method of claim 12, wherein the film includes a rolled steel layer.
